(19) United States
(12) Patent Application Publication
(10) Pub. No.: US 2025/0190825 A1
(43) Pub. Date: Jun. 12, 2025

(54) RANK EVALUATION SYSTEM, RANK EVALUATION METHOD, AND NON-TRANSITORY COMPUTER-READABLE MEDIUM

(71) Applicant: TOYOTA JIDOSHA KABUSHIKI KAISHA, Toyota-shi Aichi-ken (JP)

(72) Inventor: Shintaro YOSHIZAWA, Nagoya-shi Aichi-ken (JP)

(73) Assignee: TOYOTA JIDOSHA KABUSHIKI KAISHA, Toyota-shi Aichi-ken (JP)

(21) Appl. No.: 18/968,521

(22) Filed: Dec. 4, 2024

(30) Foreign Application Priority Data
Dec. 7, 2023 (JP) 2023-206664

(51) Int. Cl. G06N 5/045; G06N 5/02

(52) U.S. Cl. CPC G06N 5/045; G06N 5/02

(57) ABSTRACT

When the ranking of nodes changes or when a user wants to know the reason for the node ranking calculation, the user can easily and intuitively grasp the factors of change in the ranking of nodes. A rank evaluation system for evaluating ranking of nodes in a digraph composed of a plurality of interconnected nodes, the system including: matrix generation means for generating a transition probability matrix for defining a probability of transition among the nodes based on the digraph; ranking calculation means for calculating the ranking of all the nodes by calculating, using a potential function, an eigen vector of the transition probability matrix generated by the matrix generation means; and ranking visualization means for visualizing a state of the potential function corresponding to a predetermined node partitively selected from all the nodes based on the ranking of all nodes calculated by the ranking calculation means.

### CROSS REFERENCE TO RELATED APPLICATIONS

This application is based upon and claims the benefit of priority from Japanese patent application No. 2023-206664, filed on Dec. 7, 2023, the disclosure of which is incorporated herein in its entirety by reference.

### BACKGROUND

The present disclosure relates to a rank evaluation system, a rank evaluation method, and a program.

A rank evaluation system for evaluating the ranking of each node in a digraph composed of interconnected nodes is known (see, for example, Patent Literature 1).
Patent Literature 1: Japanese Patent No. 7032233

### SUMMARY

However, in a system using the aforementioned rank evaluation system or a machine learning device, for example, when the ranking of nodes changes or when a user wants to know the reason for the node ranking calculation, it is difficult for the user to grasp the factors thereof.

The present disclosure has been made to solve the problem mentioned above and an object of the present disclosure is to provide a rank evaluation system, a rank evaluation method, and a program each adapted to enable a user to easily and intuitively grasp the factors of change in the ranking of nodes in the case where the ranking of the nodes change or in the case where the user wants to know the reason for the node ranking calculation.

An aspect of the present disclosure for achieving the above object is a rank evaluation system for evaluating ranking of nodes in a digraph composed of a plurality of interconnected nodes, the system including:
matrix generation means for generating a transition probability matrix for defining a probability of transition among the nodes based on the digraph;
ranking calculation means for calculating the ranking of all the nodes by calculating, using a potential function, an eigen vector of the transition probability matrix generated by the matrix generation means; and
ranking visualization means for visualizing a state of the potential function corresponding to a predetermined node partitively selected from all the nodes based on the ranking of all the nodes calculated by the ranking calculation means.

According to this aspect, the matrix generation means is configured to generate an evaluation matrix for performing evaluation of the nodes based on the diagraph and a node evaluation criterion that have been set to thereby generate the transition probability matrix based on the generated evaluation matrix.

According to this aspect, the ranking calculation means may be configured to:
perform symmetrization of the transition probability matrix generated by the matrix generation means and set an initial state vector; and
update an initial gradient vector by a gradient equation of the potential function and calculate a state vector of the maximum eigenvalue of the transition probability matrix that has been symmetrized, thereby calculating the ranking of all the nodes.

According to this aspect, the ranking visualization means may be configured to:
determine the ranking of a state vector corresponding to the predetermined node by calculating a Hadamard product of the state vector where the potential function takes the minimum value; and
display a state of the potential function corresponding to the predetermined node on a graph of a potential function formed on at least two axes corresponding to the predetermined node.

Another aspect of the present disclosure for achieving the above object is a rank evaluation method for evaluating ranking of nodes in a digraph composed of a plurality of interconnected nodes, the method including:
a step of generating a transition probability matrix for defining a probability of transition among the nodes based on the digraph;
a step of calculating the ranking of all nodes by calculating, using a potential function, an eigen vector of the transition probability matrix generated by the matrix generation means; and
a step of visualizing a state of the potential function corresponding to a predetermined node partitively selected from all the nodes based on the calculated ranking of all the nodes.

Another aspect of the present disclosure for achieving the above object is a program for evaluating ranking of nodes in a digraph composed of a plurality of interconnected nodes, the program causing a computer to execute:
a process for generating a transition probability matrix for defining a probability of transition among the nodes based on the digraph;
a process for calculating the ranking of all the nodes by calculating, using a potential function, an eigen vector of the transition probability matrix generated by the matrix generation means; and
a process for visualizing a state of the potential function corresponding to a predetermined node partitively selected from all the nodes based on the calculated ranking of all the nodes.

According to the present disclosure, it is possible to provide a rank evaluation system, a ranking evaluation method, and a program for enabling a user to easily and intuitively grasp the factors in the case where the node ranking changes or in the case the user wants to know the reason for the node ranking calculation.

The above and other objects, features and advantages of the present disclosure will become more fully understood from the detailed description given hereinbelow and the accompanying drawings.

### BRIEF DESCRIPTION OF DRAWINGS

FIG. 1 is a block diagram schematically showing a system configuration of a rank evaluation system according to the present embodiment;

FIG. 2a is an example of a digraph;

FIG. 2b is an example of an evaluation matrix;

FIG. 2c is an example of a transition probability matrix

FIG. 3 is a diagram showing a state where eigenvalues converges to the maximum eigenvalue of a transition probability matrix;

FIG. 4 is a diagram showing an example of a state of visualized nodes;

FIG. 5 is a diagram showing an example of pairs of node coordinates at a stratification boundary of an overall ranking; and

FIG. 6 is a flowchart showing an example of a flow of a ranking evaluation method according to the present embodiment.

### DESCRIPTION OF EMBODIMENTS

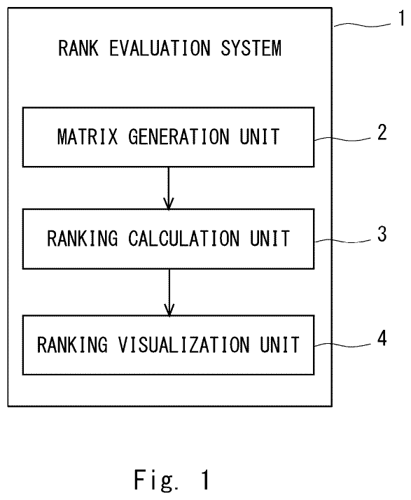

An embodiment of the present disclosure will be described below with reference to the drawings. FIG. 1 is a block diagram showing a schematic system configuration of a rank evaluation system according to the present embodiment. A rank evaluation system 1 according to the present embodiment is a system for evaluating the ranking of each node in a digraph composed of a plurality of nodes interconnected by links.

The rank evaluation system 1 according to the present embodiment includes a matrix generation unit 2, a ranking calculation unit 3, and a ranking visualization unit 4.

The rank evaluation system 1 includes, for example, a hardware configuration of an ordinary computer having a processor such as a CPU (Central Processing Unit) or GPU (Graphics Processing Unit), an internal memory such as a RAM (Random Access Memory) or a ROM (Read Only Memory), a storage device such as a HDD (Hard Disk Drive) or a SDD (Solid State Drive), an input/output I/F for connecting peripheral devices such as a display, and a communication I/F for communicating with devices external to the device.

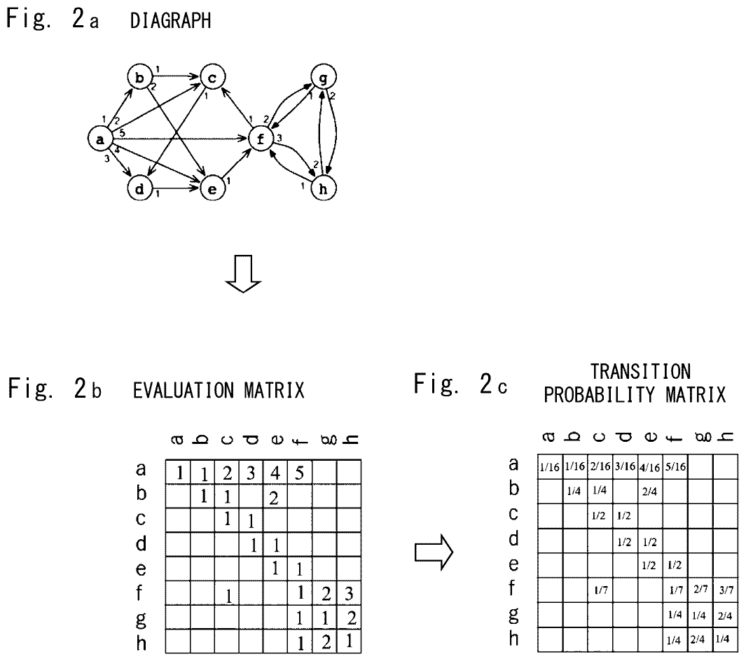

The matrix generation unit 2 is a specific example of a matrix generation means. The matrix generation unit 2 generates a transition probability matrix for defining a probability of transition among the nodes based on a digraph. As shown in FIG. 2b, the matrix generation unit 2 generates an evaluation matrix for evaluating the nodes based on the digraph and the node evaluation criterion, and generates a transition probability matrix based on the generated evaluation matrix.

First, the matrix generation unit 2 sets a node evaluation criterion for quantitatively evaluating the importance (value) of each node. The node evaluation criterion is set as, for example, the frequency of use of the node.

The matrix generation unit 2 generates, for example, a digraph including a network indicating the relationship between events based on an event log stored in a database. An event log is, for example, a log recording what kind of event occurred after an event occurred, and includes location information, a time stamp, and the like. The matrix generation unit 2 generates a digraph based on, for example, an event log with a time stamp using an algorithm such as process mining.

FIG. 2a shows an example of a digraph. The digraph shown in FIG. 2a is generated based on an evaluation criterion of the frequency of use of the nodes. As shown in FIG. 2a, for example, when the frequency at which the process of the node b occurs following the process of the node a is 1, the edge of the node a connected to the node b is set to 1.

The matrix generation unit 2 generates an evaluation matrix for evaluating the nodes by giving numerical values to the edges in the digraph, based on the node evaluation criteria set as shown in FIG. 2a. FIG. 2b shows an example of an evaluation matrix. The evaluation matrix shown in FIG. 2b evaluates the frequency of the nodes. The matrix generation unit 2 generates a transition probability matrix based on the generated evaluation matrix.

A transition probability matrix is a probability matrix representing a state transition on a finite network. In a transition probability matrix, there are one or more ways of giving evaluation of transition from one node to another node, and the probability of transition among the nodes is defined.

FIG. 2c shows an example of a transition probability matrix. In FIG. 2c, the elements of the matrix are set to be non-negative, and the column sum or the row sum is set to be 1.

Here, as shown in FIG. 2a, nodes a to h are interconnected by links having directionality and are strongly-connected. However, for example, when there is a node i that is not strongly-connected, a ranking cannot be determined for this node, and a numerical problem that the ranking of all nodes cannot be uniquely determined may occur.

In the present embodiment, as described above, even if there is a problem that there is a node that is not strongly-connected, the processing for making the node strongly-connected to other nodes is performed. Specifically, when the matrix generation unit 2 generates transition probability matrix, the weight of the node that is not strongly-connected to the other nodes is set to a small value (for example, about 0.0001 to 0.001). Thus, the ranking of all nodes can be uniquely determined while suppressing the influence of the strong-connection on the ranking of all nodes.

In the present embodiment, the matrix generation unit 2 may use the teleportation vector to make transition probability matrix an irreducible matrix.

The ranking calculation unit 3 is a specific example of a ranking calculation means. The ranking calculation unit 3 calculates an eigen vector of transition probability matrix generated by the matrix generation unit 2 using a potential function to thereby calculate the ranking of nodes.

The ranking calculation unit 3 calculates the ranking of nodes by using the Euler method to calculate the state vector, which is an eigen vector of the maximum eigenvalue of the transition probability matrix, using the gradient equation of the potential function f(x). The maximum eigenvalue is 1.

At this time, even when there is a noise mixed in the nodes, that is, when the sum of the components of the state vector does not add up to 1, the ranking calculation unit 3 can calculate the state vector of the maximum eigenvalue of the transition probability matrix by performing appropriate potential function gradient calculation as described later.

The ranking calculation unit 3 sets initial state vector A0 as described below, and updates (i.e., performs iterate operation) the initial gradient vector by the gradient equation of the potential function f(x), thereby calculating the eigen vector of the maximum eigenvalue of the transition probability matrix obtained by symmetrization. This eigen vector is a state vector X [i], and indicates the ranking of all nodes.

The following Expressions show, as an example, the case where the state variable is six dimensions, that is, the number of nodes is six.

$$[ Expression 1 ]$$

$$X [ 0 ] = bfloat ( transpose ( matrix ( [ 1 / 6 , 1 / 6 , 1 / 6 , 1 / 6 , 1 / 6 , 1 / 6 ] ) ) ) \qquad ( 1 )$$

$$A 0 : \qquad ( 2 )$$

$$A = A 0. transpose ( A 0 ) \qquad ( 3 )$$

$$V ( X ) = A . X - X . tranpose ( X ) . A . X \qquad ( 4 )$$

$$\begin{matrix}W 1 ( X ) = A . V ( X ) . transpose ( V ( X ) ) \\ W 2 ( X ) = A . X . transpose ( V ( X ) ) \\ W 3 ( X ) = A . X . transpose ( X ) \\ W 5 ( X ) = ( {A}^{2} ) . V ( X ) . transpose ( V ( X ) ) \\ W 6 ( X ) = ( {A}^{2} ) . V ( X ) . transpose ( X ) \\ W 7 ( X ) = ( {A}^{2} ) . X . transpose ( V ( X ) )\end{matrix} \} \qquad ( 5 )$$

$$/ * c 1 * {x}^{3} + c 2 * {x}^{2} + c 3 * x + c 4 = 0 * / \\ c 1 ( X ) = mat\_trace ( {( W 1 ( X ) )}^{2} ) \\ c 2 ( X ) = 3 \cdot mat\_trace ( W 1 ( X ) . W 2 ( X ) ) \\ c 3 ( X ) = 2 \cdot mat\_trace ( {( W 2 ( X ) )}^{2} ) + mat\_trace ( W 1 ( X ) . W 3 ( X ) ) + 2 \cdot mat\_trace ( W 5 ( X ) ) \\ c 4 ( X ) = mat\_trace ( W 2 ( X ) . W 3 ( X ) ) - 0.5 \cdot mat\_trace ( W 6 ( X ) + W 7 ( X ) ) \\ f ( x , X ) = c 1 ( X ) \cdot {x}^{3} + c 2 ( X ) \cdot {x}^{2} + c 3 ( X ) \cdot x + c 4 ( X ) \qquad ( 6 )$$

$$N = 10 \qquad ( 7 )$$

$$for i : I step I thru N do X [ i ] = bfloat ( X [ i - 1 ] + ( find\_root ( f ( x , X [ i - 1 ] ) , x , - 10 , 10 ) ) \cdot ( V ( X [ i - 1 ] ) ) ) \qquad ( 8 )$$

In the above expressions, Expression (1) is an initial state vector and an arbitrary real vector which is not a zero vector.

Expression (2) is a transition probability matrix generated by the aforementioned matrix generation unit 2.

Expression (3) is an expression for obtaining a positive definite symmetric matrix obtained by symmetrization of a transition probability matrix.

Expression (4) is a gradient vector field and is a gradient equation for calculating the gradient (direction vector of the tangent vector) of potential function f(x).

Expression (5) is a parameter for determining the update step size of the state vector according to Expression (6) described below.

Expression (6) is an equation (function) for determining the update step size of the state vector.

Expression (7) is a parameter for specifying the number of iterations shown below.

Expression (8) is an update expression of the state vector. Note that in Expression (8), (find_root (f (x, X [i−1]), x, −10, 10)−(V (X [i−1]))) is an expression for calculating the update step size. Therefore, in Expression (8), the state vector is updated by adding, to X [i−1], the update step size and repeating the calculation of the next X [i] for the number of iterations N (e.g., 10 times).

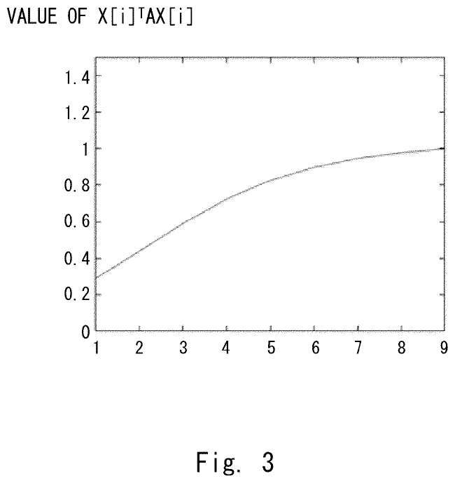

FIG. 3 shows a state where the eigenvalue X [i]^{T}AX [i] converges to transition probability matrix's maximum eigenvalue=1. As shown in FIG. 3, it can be confirmed that the eigenvalue X [i]^{T}AX [i] converges to transition probability matrix's maximum eigenvalue=1.

By updating the state vector using the above expressions the state vector can be calculated without accumulating errors even when noise is included in the middle. The update step size of the state vector can be easily obtained by solving the aforementioned Expression (6) that is a cubic equation. By utilizing this result, the state vector can be obtained easily and at a low cost by the sum product of the matrices.

By the way, for example, there may be a ranking of nodes of an interest to a user, the nodes being those which the user has involvement with. Then, a user may want to know the reason for the node ranking.

On the other hand, the ranking visualization unit 4 according to the present embodiment partitively extracts a predetermined node selected by the user or the like from the ranking of all nodes calculated by the ranking calculation unit 3, and visualizes the ranking state of the state vector of the predetermined node. Thus, since the user can easily grasp the state of the predetermined node, even when there is a change in the ranking of the nodes or when the user wants to know the reason for the node ranking calculation, the reason for the node ranking can be visually grasped.

The ranking visualization unit 4 is a specific example of a ranking visualization means. The ranking visualization unit 4 visualizes the state of potential function corresponding to a predetermined node partitively selected from all nodes based on the ranking of the entire nodes calculated by the ranking calculation unit 3. By confirming the state of the potential function corresponding to the selected predetermined node, the user can easily grasp the state of the predetermined node and visually grasp the reason for the node ranking. Selection of the predetermined node may be performed on the ranking visualization unit 4 by the user via an input device, for example.

The ranking visualization unit 4 visualizes the state of ranking of the state vectors based on the state vector X calculated by the ranking calculation unit 3. The ranking visualization unit 4 determines the ranking X of the state vectors corresponding to the predetermined node by calculating the Hadamard product (vector) of the state vectors X where potential function f(x) is below the minimum value.

$${f ( X ) = 0.25 ( transpose ( X ) . A . X ) )}^{2} - 0.5 ( transpose ( X ) . {A}^{2} . X ) )$$

Let X=(x1, x2, x3, . . . , xn) be the ranking of the state vectors determined by the above expression.

The ranking visualization unit 4 visualizes, for example, the state of potential function f(x) corresponding to a pair of node coordinates (xi, xj) selected by the user. Thus, the state of the node can be easily grasped, and the reason for the node ranking can be visually grasped. That is, in the caser where the node ranking changes or when the user wants to know the reason for the node ranking calculation, the user can easily and intuitively grasp the factors.

The ranking visualization unit 4 displays the state of a potential function corresponding to a predetermined node on a graph of the potential function f(x) formed on at least two axes corresponding to the predetermined node. The ranking visualization unit 4 graphically displays the state of the potential function f(x) corresponding to a pair of node coordinates (xi, xj) on a display screen of a display device, for example.

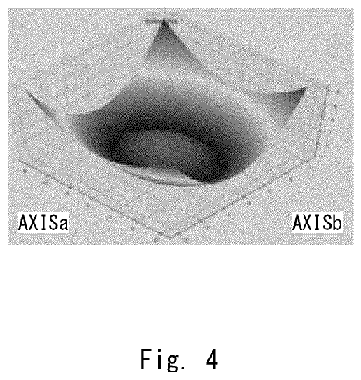

FIG. 4 is a diagram showing an example of a state of the visualized nodes. FIG. 4 is a graph of a potential function f(x) formed on two axes of axis a and axis b. In FIG. 4, each axis corresponds to each node, and the minimum value of each axis represents the value of each axis, that is, the value (ranking) of the node. Therefore, the relationship of each node corresponding to each axis can be easily grasped by taking a look at the relationship of each axis (the state of a curved surface, etc.).

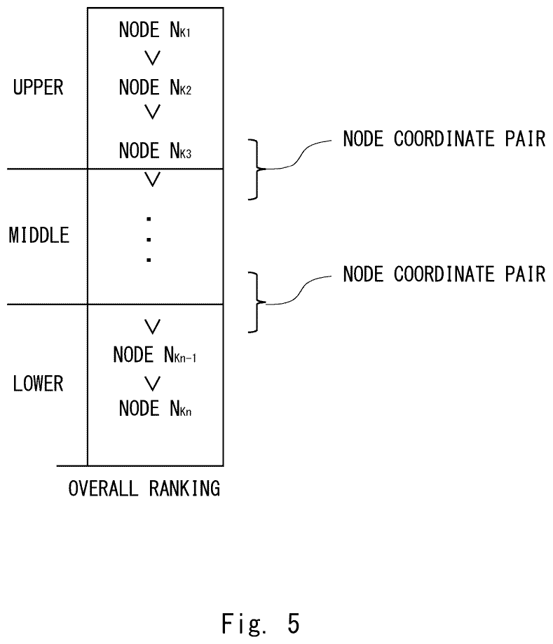

Further, the ranking visualization unit 4 may divide the overall ranking into upper, middle, and lower strata as shown in FIG. 5, and then visualize the state of the potential function by pairs of node coordinates at the boundaries of the strata.

While the ranking visualization unit 4 visualizes the state of potential function f(x) corresponding to the pairs of node coordinates (xi, xj) using a graph as shown in FIG. 4, it is not limited to this. The ranking visualization unit 4 may perform visualization by, for example, providing a cut plane (isoplane) cut at an arbitrary level (height), and any display method may be used as long as the state of the potential function f(x) can be appropriately visualized. Further, while the ranking visualization unit 4 visualizes the state of the potential function f(x) corresponding to two node coordinates, it is not limited to thereto, and the state of potential function f(x) corresponding to three or more node coordinates may be visualized.

As described above, according to the present embodiment, by visualizing the properties of the “value order” and the “probability matrix” of the nodes, the reason for the order inversion of the nodes can be easily grasped. Further, this knowledge can be utilized for modification, improvement, and update of the probability matrix.

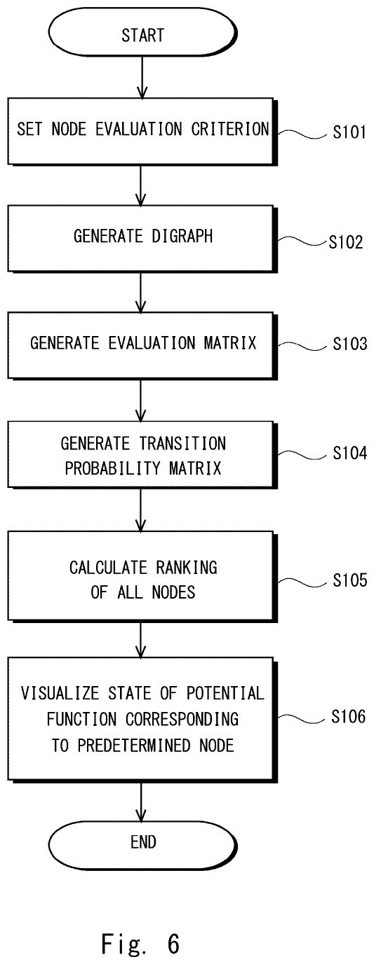

Next, a rank evaluation method according to the present embodiment will be described. FIG. 6 is a flowchart showing an example of a flow of a rank evaluation method according to the present embodiment.

The matrix generation unit 2 sets a node evaluation criterion for evaluating the importance of a node (Step S101). The matrix generation unit 2 generates a digraph based on the event log of the database (Step S102).

The matrix generation unit 2 generates an evaluation matrix for evaluating a node by assigning numerical values to the edges of digraph based on the node evaluation criterion (Step S103). The matrix generation unit 2 generates a transition probability matrix for defining the probability of transition among the nodes based on the generated evaluation matrix (Step S104).

The ranking calculation unit 3 symmetrizes the transition probability matrix generated by the matrix generation unit 2 and updates the initial gradient vector by the potential function gradient equation to calculate the state vector of the maximum eigenvalue of the transition probability matrix which has been symmetrized, thereby calculating the ranking of all nodes (Step S105).

The ranking visualization unit 4 determines the ranking of the state vectors corresponding to the predetermined node by calculating the Hadamard product of the state vectors where the potential function is the minimum value. The ranking visualization unit 4 then visualizes the state of the potential function corresponding to the predetermined node (Step S106).

While several example embodiments of the present disclosure have been described, they are presented as examples and are not intended to limit the scope of present disclosure. These noble example embodiments can be implemented in a variety of other forms, and various omissions, replacements, and modifications can be made to the extent that they do not deviate from the gist of present disclosure. These and other variations are included in the scope and the gist of present disclosure and are equally within the scope of present disclosure described in the claims and the equivalents thereof.

The present disclosure may realize the processing shown in FIG. 6, for example, by causing a processor to execute a computer program.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.).

The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The structural elements of the rank evaluation system 1 described in the aforementioned embodiments cannot only be realized by the program but can also be realized by exclusive hardware such as ASIC (Application Specific Integrated Circuit) and FPGA (Field-Programmable Gate Array).

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A rank evaluation system for evaluating ranking of nodes in a digraph composed of a plurality of interconnected nodes, the system comprising:
matrix generation means for generating a transition probability matrix for defining a probability of transition among the nodes based on the digraph;
ranking calculation means for calculating the ranking of all the nodes by calculating, using a potential function, an eigen vector of the transition probability matrix generated by the matrix generation means; and
ranking visualization means for visualizing a state of the potential function corresponding to a predetermined node partitively selected from all the nodes based on the ranking of all the nodes calculated by the ranking calculation means.

2. The rank evaluation system according to claim 1, wherein the ranking calculation means is configured to:
perform symmetrization of the transition probability matrix generated by the matrix generation means and set an initial state vector; and
update an initial gradient vector by a gradient equation of the potential function and calculate a state vector of a maximum eigenvalue of the transition probability matrix that has been symmetrized, thereby calculating the ranking of all the nodes.

3. The rank evaluation system according to claim 1, wherein the ranking visualization means is configured to:
determine the ranking of a state vector corresponding to the predetermined node by calculating a Hadamard product of the state vector where the potential function takes a minimum value; and
display a state of the potential function corresponding to the predetermined node on a graph of a potential function formed on at least two axes corresponding to the predetermined node.

4. The rank evaluation system according to claim 1, wherein the matrix generation means, the ranking calculation means, and the ranking visualization means are a central processing unit.

5. The rank evaluation system according to claim 2, wherein the matrix generation means, the ranking calculation means, and the ranking visualization means are a central processing unit.

6. The rank evaluation system according to claim 3, wherein the matrix generation means, the ranking calculation means, and the ranking visualization means are a central processing unit.

7. A rank evaluation method for evaluating ranking of nodes in a digraph composed of a plurality of interconnected nodes, the method comprising:
a step of generating a transition probability matrix for defining a probability of transition among the nodes based on the digraph;
a step of calculating the ranking of all nodes by calculating, using a potential function, an eigen vector of the generated transition probability matrix; and
a step of visualizing a state of the potential function corresponding to a predetermined node partitively selected from all the nodes based on the calculated ranking of all the nodes.

8. A non-transitory computer-readable medium for storing a program for evaluating ranking of nodes in a digraph composed of a plurality of interconnected nodes, the program causing a computer to execute:
a process for generating a transition probability matrix for defining a probability of transition among the nodes based on the digraph;
a process for calculating the ranking of all the nodes by calculating, using a potential function, an eigen vector of the generated transition probability matrix; and
a process for visualizing a state of the potential function corresponding to a predetermined node partitively selected from all the nodes based on the calculated ranking of all the nodes.
